(19) United States
(12) Patent Application Publication
(10) Pub. No.: US 2011/0104493 A1
(43) Pub. Date: May 5, 2011

(54) POLYPROPYLENE FIBROUS ELEMENTS AND PROCESSES FOR MAKING SAME

(76) Inventors: Steven Lee Barnholtz, West Chester, OH (US); Paul Dennis Trokhan, Hamilton, OH (US)

(21) Appl. No.: 12/917,558

(22) Filed: Nov. 2, 2010

Related U.S. Application Data
(60) Provisional application No. 61/257,269, filed on Nov. 2, 2009.

(51) Int. Cl. D02G 3/02; C08L 23/12; C08L 53/00

(52) U.S. Cl. 428/401; 525/240; 525/95; 524/528; 524/13

(57) ABSTRACT

Polypropylene fibrous elements and more particularly polypropylene microfiber fibrous elements, fibrous structures including polypropylene fibrous elements, and processes for making same are provided.

### CROSS REFERENCE TO RELATED APPLICATION

This application claims the benefit of U.S. Provisional Application No. 61/257,269, filed Nov. 2, 2009.

### FIELD OF THE INVENTION

The present invention relates to polypropylene fibrous elements and more particularly to polypropylene microfiber (less than 10 μm in diameter) fibrous elements, and processes for making same.

### BACKGROUND OF THE INVENTION

Polypropylene compositions have been used for many years to produce polypropylene microfiber fibrous elements, such as polypropylene microfiber filaments. Such polypropylene microfiber fibrous elements are used in fibrous structures, such as fibrous structures that are incorporated into sanitary tissue products.

Formulators have utilized polypropylene polymers of a single melt flow rate (MFR) to achieve stretch in polypropylene microfiber fibrous elements, and in fibrous structures incorporating such polypropylene microfiber fibrous elements. However, it is known that by improving the stretch and/or elongation of polypropylene microfiber fibrous elements, processability and spin rates of such polypropylene microfiber fibrous elements are negatively impacted.

Formulators have found that by using a polypropylene composition comprising a blend of two polypropylene polymers having different MFRs results in a polypropylene microfiber fibrous element that exhibits increased elongation and is capable of being spun at high speeds.

It is known that the higher the MFR of a polypropylene polymer, the better the spinnability of the polypropylene polymer, but the poorer the strength of the polypropylene microfiber fibrous element made from such polypropylene polymer.

It is known that the lower the MFR of a polypropylene polymer, the better the strength of the polypropylene microfiber fibrous element, but the poorer the microfiber fibrous element spinnability of the polypropylene polymer.

It is know that spinning a polypropylene composition comprising two polypropylene polymers having different MFRs, the better the microfiber fibrous element spinnability of the polypropylene polymer, but the poorer the elongating and strength of the polypropylene microfiber fibrous element.

Accordingly, there is a need for a polypropylene microfiber fibrous element, such as a polypropylene microfiber filament, and a polypropylene composition that comprises a mixture of polypropylene polymers, such as three or more polypropylene polymers, that provide better polypropylene microfiber fibrous element spinnability of the polypropylene polymer composition as well as better elongation and better strength of the polypropylene microfiber fibrous elements and a process for making such polypropylene microfiber fibrous elements.

### SUMMARY OF THE INVENTION

The present invention fulfills the needs described above by providing a polypropylene microfiber fibrous element comprising a polypropylene composition comprising three or more polypropylene polymers such that the polypropylene microfiber fibrous element exhibits greater polypropylene microfiber fibrous element spinnability, elongation and strength and a process for making such polypropylene microfiber fibrous element.

In one example of the present invention, a polypropylene microfiber fibrous element comprising a polypropylene composition comprising:

a. a first polypropylene polymer that exhibits a melt flow rate of less than 50 g/10 min;

b. a second polypropylene polymer that exhibits a melt flow rate of from about 200 to about 700 g/10 min; and

c. a third polypropylene polymer that exhibits a melt flow rate of greater than 1000 g/10 min, is provided.

In another example of the present invention, a fibrous structure comprising one or more polypropylene microfiber fibrous elements according to the present invention, is provided.

In another example of the present invention, a polypropylene microfiber fibrous element made from a polypropylene composition comprising:

a. a first polypropylene polymer that exhibits a melt flow rate of less than 50 g/10 min;

b. a second polypropylene polymer that exhibits a melt flow rate of from about 200 to about 700 g/10 min; and

c. a third polypropylene polymer that exhibits a melt flow rate of greater than 1000 g/10 min, is provided.

In yet another example of the present invention, a process for making a polypropylene microfiber fibrous element, the process comprising the step of spinning a microfiber fibrous element from a polypropylene composition comprising:

a. a first polypropylene polymer that exhibits a melt flow rate of less than 50 g/10 min;

b. a second polypropylene polymer that exhibits a melt flow rate of from about 200 to about 700 g/10 min; and

c. a third polypropylene polymer that exhibits a melt flow rate of greater than 1000 g/10 min, is provided.

In still another example of the present invention, a fibrous structure comprising a plurality of polypropylene filaments and a plurality of solid additives, wherein the polypropylene present in the polypropylene filaments exhibits a weight average molecular weight of at least 78,000 and a polydispersity of less than 3.2, is provided.

Accordingly, the present invention provides a polypropylene microfiber fibrous element, a fibrous structure comprising same and a process for making same.

### DETAILED DESCRIPTION OF THE INVENTION

### Definitions

“Fibrous element” as used herein means an elongate particulate having a length greatly exceeding its average diameter, i.e. a length to average diameter ratio of at least about 10. A fibrous element may be a filament or a fiber. In one example, the fibrous element is a single fibrous element rather than a yarn comprising a plurality of fibrous elements.

The polypropylene microfiber fibrous elements of the present invention may be spun from polypropylene compositions such as polypropylene melt compositions, via suitable spinning operations, such as meltblowing.

Other fibrous elements may be spun from spinning composition such as polymer melt compositions, via suitable spinning operations, such as spunbonding and/or they may be obtained from natural sources such as vegetative sources, for example trees.

The fibrous elements of the present invention may be monocomponent or multicomponent. For example, the fibrous elements may comprise bicomponent fibers and/or filaments. The bicomponent fibers and/or filaments may be in any form, such as side-by-side, core and sheath, islands-in-the-sea and the like.

“Filament” as used herein means an elongate particulate as described above that exhibits a length of greater than or equal to 5.08 cm (2 in.) and/or greater than or equal to 7.62 cm (3 in.) and/or greater than or equal to 10.16 cm (4 in.) and/or greater than or equal to 15.24 cm (6 in.).

Filaments are typically considered continuous or substantially continuous in nature. Filaments are relatively longer than fibers. Non-limiting examples of filaments include meltblown and/or spunbond filaments.

“Fiber” as used herein means an elongate particulate as described above that exhibits a length of less than 5.08 cm (2 in.) and/or less than 3.81 cm (1.5 in.) and/or less than 2.54 cm (1 in.).

Fibers are typically considered discontinuous in nature. Non-limiting examples of fibers include pulp fibers, such as wood pulp fibers, and synthetic staple fibers such as polypropylene, polyethylene, polyester, copolymers thereof, rayon, glass fibers and polyvinyl alcohol fibers.

Staple fibers may be produced by spinning a filament tow and then cutting the tow into segments of less than 5.08 cm (2 in.) thus producing fibers.

In one example of the present invention, a fiber may be a naturally occurring fiber, which means it is obtained from a naturally occurring source, such as a vegetative source, for example a tree and/or plant. Such fibers are typically used in papermaking and are oftentimes referred to as papermaking fibers. Papermaking fibers useful in the present invention include cellulosic fibers commonly known as wood pulp fibers. Applicable wood pulps include chemical pulps, such as Kraft, sulfite, and sulfate pulps, as well as mechanical pulps including, for example, groundwood, thermomechanical pulp and chemically modified thermomechanical pulp. Chemical pulps, however, may be preferred since they impart a superior tactile sense of softness to tissue sheets made therefrom. Pulps derived from both deciduous trees (hereinafter, also referred to as “hardwood”) and coniferous trees (hereinafter, also referred to as “softwood”) may be utilized. The hardwood and softwood fibers can be blended, or alternatively, can be deposited in layers to provide a stratified web. Also applicable to the present invention are fibers derived from recycled paper, which may contain any or all of the above categories of fibers as well as other non-fibrous polymers such as fillers, softening agents, wet and dry strength agents, and adhesives used to facilitate the original papermaking.

In addition to the various wood pulp fibers, other cellulosic fibers such as cotton linters, rayon, lyocell and bagasse fibers can be used in the fibrous structures of the present invention.

“Fibrous structure” as used herein means a structure that comprises one or more filaments and/or fibers. In one example, a fibrous structure according to the present invention means an orderly arrangement of filaments and/or fibers within a structure in order to perform a function. In another example, a fibrous structure according to the present invention is a nonwoven.

The fibrous structures of the present invention may be homogeneous or may be layered. If layered, the fibrous structures may comprise at least two and/or at least three and/or at least four and/or at least five layers.

The fibrous structures of the present invention may be co-formed fibrous structures. In one example, the fibrous structures of the present invention are disposable. For example, the fibrous structures of the present invention are non-textile fibrous structures. In another example, the fibrous structures of the present invention are flushable, such as toilet tissue.

Non-limiting examples of processes for making fibrous structures include known wet-laid papermaking processes and air-laid papermaking processes. Such processes typically include the steps of preparing a fibrous element composition, such as a fiber composition, in the form of a suspension in a medium, either wet, more specifically an aqueous medium, i.e., water, or dry, more specifically a gaseous medium, i.e. air. The suspension of fibers within an aqueous medium is oftentimes referred to as a fiber slurry. The fibrous suspension is then used to deposit a plurality of fibers onto a forming wire or belt such that an embryonic fibrous structure is formed, after which drying and/or bonding the fibers together results in the association of the fibers into a fibrous structure. Further processing the fibrous structure may be carried out such that a finished fibrous structure is formed. For example, in typical papermaking processes, the finished fibrous structure is the fibrous structure that is wound on the reel at the end of papermaking. The finished fibrous structure may subsequently be converted into a finished product, e.g. a sanitary tissue product.

In one example, the fibrous structure of the present invention is a “unitary fibrous structure.”

“Unitary fibrous structure” as used herein is an arrangement comprising a plurality of two or more and/or three or more fibrous elements that are inter-entangled or otherwise associated with one another to form a fibrous structure. A unitary fibrous structure in accordance with the present invention may be incorporated into a fibrous structure according to the present invention. A unitary fibrous structure of the present invention may be one or more plies within a multi-ply fibrous structure. In one example, a unitary fibrous structure of the present invention may comprise three or more different fibrous elements. In another example, a unitary fibrous structure of the present invention may comprise two different fibrous elements, for example a co-formed fibrous structure, upon which a different fibrous element is deposited to form a fibrous structure comprising three or more different fibrous elements.

“Co-formed fibrous structure” as used herein means that the fibrous structure comprises a plurality of filaments and a plurality of fibers. In one example, a co-formed fibrous structure comprises non-polysaccharide polymer filaments and wood pulp fibers.

“Solid additive” as used herein means a fiber and/or a particulate.

“Particulate” as used herein means a granular substance or powder.

“Sanitary tissue product” as used herein means a soft, low density (i.e. <about 0.15 g/cm³) web useful as a wiping implement for post-urinary and post-bowel movement cleaning (toilet tissue), for otorhinolaryngological discharges (facial tissue), and multi-functional absorbent and cleaning uses (absorbent towels). Non-limiting examples of suitable sanitary tissue products of the present invention include paper towels, bath tissue, facial tissue, napkins, baby wipes, adult wipes, wet wipes, cleaning wipes, polishing wipes, cosmetic wipes, car care wipes, wipes that comprise an active agent for performing a particular function, cleaning substrates for use with implements, such as a Swiffer® cleaning wipe/pad. The sanitary tissue product may be convolutedly wound upon itself about a core or without a core to form a sanitary tissue product roll.

In one example, the sanitary tissue product of the present invention comprises one or more fibrous structures according to the present invention.

The sanitary tissue products of the present invention may exhibit a basis weight between about 10 g/m² to about 120 g/m² and/or from about 15 g/m² to about 110 g/m² and/or from about 20 g/m² to about 100 g/m² and/or from about 30 to 90 g/m². In addition, the sanitary tissue product of the present invention may exhibit a basis weight between about 40 g/m² to about 120 g/m² and/or from about 50 g/m² to about 110 g/m² and/or from about 55 g/m² to about 105 g/m² and/or from about 60 to 100 g/m².

The sanitary tissue products of the present invention may be in the form of sanitary tissue product rolls. Such sanitary tissue product rolls may comprise a plurality of connected, but perforated sheets of fibrous structure, that are separably dispensable from adjacent sheets.

The sanitary tissue products of the present invention may comprises additives such as softening agents, temporary wet strength agents, permanent wet strength agents, bulk softening agents, lotions, silicones, wetting agents, latexes, patterned latexes and other types of additives suitable for inclusion in and/or on sanitary tissue products.

“Polymer” as used herein includes, but is not limited to, homopolymers, copolymers, terpolymers, etc. and blends (two or more polymers mixed together) and alloys (a blend in which the polymer components are immiscible but have been compatibilized). The term “polymer” as used herein also includes impact, block, graft, random and alternating copolymers. The term “polymer” as used herein also includes all possible geometrical configurations unless otherwise specifically stated. Such configurations may include isotactic, syndiotactic and random symmetries. “Miscible” and “immiscible” refers to blends, such as alloys, having negative and positive values, respectively, of the free energy mixing. “Compatibilized” as used herein means that the interfacial properties of an immiscible blend have been modified in order to make an alloy.

“Polypropylene polymer” as used herein includes homopolymers of polypropylene, copolymers of polypropylene, and mixtures thereof. In one example, a polymer that has been derived from one or more and/or two or more and/or three or more and/or four or more monomers of propylene is considered a polypropylene polymer for purposes of the present invention.

“Melt flow rate” or “MFR” as used herein is a measure of the viscosity of a polymer or polymer blend. The MFR is expressed as the weight of material which flows from a capillary of known dimensions under a load of 2.16 kg for 10 minutes and is measured in grams/10 minutes (g/10 min) at 230° C. according to the ASTM D-1238 test, condition 230/2.16.

“Wetting agent” as used herein means a material in present in and/or on a fibrous element of the present invention, wherein the material that lowers the surface tension of a liquid, such as water, coming into contact with a surface of the fibrous element, allowing easier spreading and lower interfacial tension between the liquid and the surface.

“Weight average molecular weight” as used herein means the weight average molecular weight as determined using gel permeation chromatography according to the protocol found in Colloids and Surfaces A. Physico Chemical & Engineering Aspects, Vol. 162, 2000, pg. 107-121.

“Polydispersity” as used herein means molecular-weight nonhomogeneity in a polymer system; that is, there is some molecular-weight distribution throughout the body of the polymer. Polydispersity is measured using gel permeation chromatography according to the protocol found in Colloids and Surfaces A. Physico Chemical & Engineering Aspects, Vol. 162, 2000, pg. 107-121.

“Length” as used herein, with respect to a fibrous element, means the length along the longest axis of the fibrous element from one terminus to the other terminus. If a fibrous element has a kink, curl or curves in it, then the length is the length along the entire path of the fibrous element. If a portion of the fibrous element is bonded to another fibrous element such that both termini are not discernible, such as a thermal bond site, then the an effective terminus of such a fibrous element is the point of the fibrous element immediately prior to the bond site.

“Diameter” as used herein, with respect to a fibrous element, is measured according to the Diameter Test Method described herein.

“Microfiber” as used herein with reference to fibrous elements refers to a fibrous element, such as a filament, that exhibits a diameter of less than 10 μm and/or less than 5 μm and/or less than 2 μm and/or less than 1.5 μm and/or less than 1 μm and/or greater than 0.01 μm and/or greater than 0.1 μm and/or greater than 0.5 μm as measured according to the Diameter Test Method described herein.

“Basis Weight” as used herein is the weight per unit area of a sample reported in lbs/3000 ft² or g/m².

“Ply” or “Plies” as used herein means an individual fibrous structure optionally to be disposed in a substantially contiguous, face-to-face relationship with other plies, forming a multiple ply fibrous structure. It is also contemplated that a single fibrous structure can effectively form two “plies” or multiple “plies”, for example, by being folded on itself.

As used herein, the articles “a” and “an” when used herein, for example, “an anionic surfactant” or “a fiber” is understood to mean one or more of the material that is claimed or described.

All percentages and ratios are calculated by weight unless otherwise indicated. All percentages and ratios are calculated based on the total composition unless otherwise indicated.

Unless otherwise noted, all component or composition levels are in reference to the active level of that component or composition, and are exclusive of impurities, for example, residual solvents or by-products, which may be present in commercially available sources.

### Polypropylene Microfiber Fibrous Elements

The polypropylene microfiber fibrous elements of the present invention comprise a polypropylene composition comprising three or more different MFR polypropylene polymers. In one example, the polypropylene microfiber fibrous element of the present invention comprises a polypropylene composition comprising a polypropylene polymer that exhibits a MFR of less than 50 g/10 min and/or less than 45 g/10 min and/or less than 40 g/10 min and/or to about 15 g/10 min and/or to about 20 g/10 min and/or to about 25 g/10 min and/or to about 30 g/10 min. In one example, the polypropylene polymer exhibits a MFR of from about 15 g/10 min to less than 50 g/10 min.

In another example, the polypropylene microfiber fibrous element of the present invention comprises a polypropylene composition comprising a polypropylene polymer that exhibits a MFR of from about 200 g/10 min and/or from about 300 g/10 min and/or from about 400 g/10 min and/or to about 700 g/10 min and/or to about 600 g/10 min and/or to about 550 g/10 min. In one example, the polypropylene polymer exhibits a MFR of from about 300 g/10 min to about 600 g/10 min.

In yet another example, the polypropylene fibrous element of the present invention comprises a polypropylene composition comprising a polypropylene polymer that exhibits a MFR of greater than 1000 g/10 min and/or greater than 1100 g/10 min and/or greater than 1200 g/10 min and/or greater than 1300 g/10 min and/or to about 2000 g/10 min and/or to about 1800 g/10 min and/or to about 1600 g/10 min and/or to about 1500 g/10 min. In one example, the polypropylene polymer exhibits a MFR from about 1,000 to about 2,000 g/10 min.

The polypropylene composition from which the polypropylene microfiber fibrous element is produced may comprise from about 5 to about 30% by weight of the polypropylene composition of a polypropylene polymer that exhibits a MFR of less than 50 g/10 min and/or from about 20 to about 60% by weight of the polypropylene composition of a polypropylene polymer that exhibits a MFR of from about 200 g/10 min to about 700 g/10 min and/or from about 10 to about 60% by weight of the polypropylene composition of a polypropylene polymer that exhibits a MFR of greater than 1000 g/10 min.

In one example, the polypropylene composition of the present invention comprises a first polypropylene polymer that exhibits a MFR of less than 50 g/10 min and a second polypropylene polymer that exhibits a MFR of from about 200 to about 700 g/10 min at a weight ratio of first polypropylene polymer to second polypropylene polymer of from about 1.5:1 to about 1:12.

In another example, the polypropylene composition of the present invention comprises a first polypropylene polymer that exhibits a MFR of less than 50 g/10 min and a another polypropylene polymer that exhibits a MFR of greater than 1000 g/10 min at a weight ratio of first polypropylene polymer to other polypropylene polymer of from about 3:1 to about 1:12.

In yet another example, the polypropylene composition of the present invention comprises a polypropylene polymer that exhibits a MFR of from about 200 to about 700 g/10 min and another polypropylene polymer that exhibits a MFR of greater than 1000 g/10 min at a weight ratio of the first polypropylene polymer to the second polypropylene polymer of from about 6:1 to about 1:3.

The polypropylene microfiber fibrous element may comprise at least one polypropylene copolymer. The polypropylene microfiber fibrous element may comprise at least one polypropylene homopolymer.

In one example of the present invention, the polypropylene microfiber fibrous element may comprise an elastomeric polypropylene polymer. The elastomeric polypropylene polymer may comprise a polypropylene copolymer. The elastomeric polypropylene polymer may be a polyethylene/polypropylene block copolymer.

In one example, the polypropylene microfiber fibrous element may comprise a wetting agent. The wetting agent may be a melt additive wetting agent that is present in the polypropylene composition prior to spinning of the polypropylene microfiber fibrous element. Alternatively or in addition to the melt additive wetting agent, the polypropylene fibrous element may comprise a surface wetting agent that is applied to a surface of the fibrous element. Non-limiting examples of wetting agents include surfactants, such as Triton X-100. Non-limiting examples of melt additive wetting agents include hydrophilic modifying melt additives such as VW351 and S-1416, both commercially available from Polyvel, Inc. and Irgasurf commercially available from Ciba. The melt additive wetting agent may be associated with the polypropylene microfiber fibrous element at any suitable level known in the art. In one example, the melt additive wetting agent may be present in the polypropylene microfiber fibrous element at a level of less than about 20% and/or less than about 15% and/or less than about 10% and/or less than about 5% and/or less than about 3% to about 0% by weight of the polypropylene microfiber fibrous element. In another example, the melt additive wetting agent may be present in the polypropylene microfiber fibrous element at a level of greater than 0% and/or greater than 0.5% and/or greater than 0.75% to less than 2% and/or less than 1.75% and/or less than 1.5% by weight of the polypropylene microfiber fibrous element.

The polypropylene microfiber fibrous elements of the present invention may associate to form a fibrous structure of the present invention.

In one example, the polypropylene microfiber fibrous element comprises a polypropylene microfiber filament.

The polypropylene microfiber fibrous elements may be a single component (i.e., single synthetic material or mixture makes up entire polypropylene microfiber fibrous element), bi-component (i.e., the polypropylene microfiber fibrous element is divided into regions, the regions including two or more different polymers or mixtures thereof and may include co-extruded polypropylene microfiber fibrous elements) and mixtures thereof. It is also possible to use bicomponent polypropylene microfiber fibrous elements, or simply bicomponent or sheath polymers. These bicomponent polypropylene microfiber fibrous elements can be used as a component polypropylene microfiber fibrous element of the structure, and/or they may be present to act as a binder for other fibrous elements present in the fibrous structure. Any or all of the fibrous elements may be treated before, during, or after the process of the present invention to change any desired properties of the fibrous elements.

Non-limiting examples of polypropylene polymers present in the polypropylene composition from which the polypropylene microfiber fibrous elements are produced are commercially available from ExxonMobil, Sunoco and Lyondell-Basell.

### Fibrous Structures

The fibrous structures of the present invention may comprise one or more polypropylene microfiber fibrous elements. In one example, a fibrous structure of the present invention comprises a plurality of polypropylene microfiber fibrous elements, such as polypropylene microfiber filaments. In another example, a fibrous structure of the present invention may comprise a plurality of polypropylene microfiber fibrous elements, such as polypropylene microfiber filaments, and a plurality of solid additives, such as wood pulp fibers and/or absorbent gel material additives and/or filler particles and/or particulate spot bonding powders and/or clays. The polypropylene microfiber fibrous elements may be randomly arranged as a result of the process by which they are spun and/or formed into the fibrous structure. The solid additives may be randomly dispersed throughout the fibrous structure in the x-y plane. The solid additives may be non-randomly dispersed throughout the fibrous structure in the z-direction. In one example, the solid additives are present at a higher concentration on one or more of the exterior, x-y plane surfaces than within the fibrous structure along the z-direction.

In another example, the fibrous structure of the present invention comprises two or more layers, thus being a layered fibrous structure.

In another example one or more plies comprising at least one fibrous structure in accordance with the present invention may form a part of a sanitary tissue product. The plies may be bonded together, such as by thermal bonding and/or adhesive bonding, to form a multi-ply sanitary tissue product.

In one example, the fibrous structure that exhibits a basis weight of at least about 15 g/m² and/or at least about 20 g/m² and/or at least about 25 g/m² and/or at least about 30 g/m² up to about 120 g/m² and/or 100 g/m² and/or 80 g/m² and/or 60 g/m², when present, independently and individually, may comprise fibrous structures that exhibit basis weights of less than about 10 g/m² and/or less than about 7 g/m² and/or less than about 5 g/m² and/or less than about 3 g/m² and/or less than about 2 g/m² and/or to about 0 g/m² and/or 0.5 g/m².

The fibrous structures of the present invention may comprise any suitable amount of polypropylene microfiber fibrous elements and any suitable amount of solid additives. For example, the fibrous structures may comprise from about 10% to about 70% and/or from about 20% to about 60% and/or from about 30% to about 50% by dry weight of the fibrous structure of polypropylene microfiber fibrous elements, such as polypropylene microfiber filaments, and from about 90% to about 30% and/or from about 80% to about 40% and/or from about 70% to about 50% by dry weight of the fibrous structure of solid additives, such as wood pulp fibers.

The polypropylene microfiber fibrous elements and solid additives of the present invention may be present in fibrous structures according to the present invention at weight ratios of polypropylene microfiber fibrous elements to solid additives of from at least about 1:1 and/or at least about 1:1.5 and/or at least about 1:2 and/or at least about 1:2.5 and/or at least about 1:3 and/or at least about 1:4 and/or at least about 1:5 and/or at least about 1:7 and/or at least about 1:10.

In one example, the polypropylene present in the polypropylene microfiber filaments exhibits a weight average molecular weight of at least 78,000 g/mol and/or at least 80,000 g/mol and/or at least 82,000 g/mol and/or at least 85,000 g/mol and/or to about 500,000 g/mol and/or to about 400,000 g/mol and/or to about 200,000 g/mol and/or to about 100,000 g/mol.

The polypropylene present in the polypropylene microfiber filaments exhibits a polydispersity of less than 3.2 and/or less than 3.1 and/or less than 3.0.

The fibrous structures of the present invention and/or any sanitary tissue products comprising such fibrous structures may be subjected to any post-processing operations such as embossing operations, printing operations, tuft-generating operations, thermal bonding operations, ultrasonic bonding operations, perforating operations, surface treatment operations such as application of lotions, silicones and/or other materials and mixtures thereof.

The fibrous structures of the present invention may include optional additives, each, when present, at individual levels of from about 0% and/or from about 0.01% and/or from about 0.1% and/or from about 1% and/or from about 2% to about 95% and/or to about 80% and/or to about 50% and/or to about 30% and/or to about 20% by dry weight of the fibrous structure. Non-limiting examples of optional additives include permanent wet strength agents, temporary wet strength agents, dry strength agents such as carboxymethylcellulose and/or starch, softening agents, lint reducing agents, opacity increasing agents, wetting agents, odor absorbing agents, perfumes, temperature indicating agents, color agents, dyes, osmotic materials, microbial growth detection agents, antibacterial agents and mixtures thereof.

The fibrous structure of the present invention may itself be a sanitary tissue product. It may be convolutedly wound about a core to form a roll. It may be combined with one or more other fibrous structures as a ply to form a multi-ply sanitary tissue product. In one example, a co-formed fibrous structure of the present invention may be convolutedly wound about a core to form a roll of co-formed sanitary tissue product. The rolls of sanitary tissue products may also be coreless.

The fibrous structure of the present invention may exhibit an elongation of greater than 50% and/or greater than 60% and/or greater than 70% and/or greater than 80% to about 100% and/or to about 90% as measured according to the Elongation Test Method described herein.

The fibrous structure of the present invention may exhibit a total dry tensile of greater than 400 g/in as measured according to the Total Dry Tensile Test Method described herein.

The fibrous structure of the present invention may exhibit a basis weight of greater than 10 g/m² and/or greater than 20 g/m² and/or greater than 30 g/m² to about 120 g/m² and/or to about 100 g/m² and/or to about 80 g/m².

In one example, the fibrous structure of the present invention may exhibit a total dry tensile/filament basis weight value of greater than 20 g/in/g/m² and/or greater than 30 g/in/ g/m² and/or greater than 40 g/in/g/m².

### Process For Making A Polypropylene Microfiber Fibrous Element

The polypropylene microfiber fibrous elements of the present invention may be made by any suitable process known in the art. In one example a process for making a polypropylene microfiber fibrous element of the present invention comprises the step of spinning a microfiber fibrous element from a polypropylene composition comprising:

a. a first polypropylene polymer that exhibits a melt flow rate of less than 50 g/10 min;

b. a second polypropylene polymer that exhibits a melt flow rate of from about 200 to about 700 g/10 min; and

c. a third polypropylene polymer that exhibits a melt flow rate of greater than 1000 g/10 min.

In one example, the polypropylene composition further comprises a melt additive wetting agent.

In another example, the process comprises applying a surface wetting agent to the fibrous element.

### Process For Making A Fibrous Structure

A non-limiting example of a process for making a fibrous structure according to the present invention comprises the step of mixing a plurality of solid additives, such as wood pulp fibers, with a plurality of polypropylene microfibers fibrous elements, such as polypropylene microfiber filaments, to form a fibrous structure.

The solid additives may comprise SSK fibers and/or Eucalyptus fibers. The solid additives may be combined with the polypropylene microfiber fibrous elements, such as by being delivered to a stream of polypropylene microfiber fibrous elements from a hammermill via a solid additive spreader to form a mixture of polypropylene microfiber fibrous elements and solid additives.

The polypropylene microfiber fibrous elements may be created by meltblowing from a meltblow die. In one example, the polypropylene present in the polypropylene microfiber fibrous elements of the present invention may exhibit a weight average molecular weight of at least 78,000 and/or a polydispersity of less than 3.3.

The mixture of solid additives and polypropylene microfiber fibrous elements are collected on a collection device, such as a belt to form a fibrous structure. The collection device may be a patterned and/or molded belt that results in the fibrous structure exhibiting a surface pattern, such as a non-random, repeating pattern. The molded belt may have a three-dimensional pattern on it that gets imparted to the fibrous structure during the process.

After the fibrous structure has been formed on the collection device, the fibrous structure may be subjected to post-processing operations such as embossing, thermal bonding, tuft-generating operations, moisture-imparting operations, and surface treating operations to form a finished fibrous structure. One example of a surface treating operation that the fibrous structure may be subjected to is the surface application of an elastomeric binder, such as ethylene vinyl acetate (EVA), latexes, and other elastomeric binders. Such an elastomeric binder may aid in reducing the lint created from the fibrous structure during use by consumers. The elastomeric binder may be applied to one or more surfaces of the fibrous structure in a pattern, especially a non-random repeating pattern, or in a manner that covers or substantially covers the entire surface(s) of the fibrous structure.

The process for making a fibrous structure may be close coupled (where the fibrous structure is convolutedly wound into a roll prior to proceeding to a converting operation) or directly coupled (where the fibrous structure is not convolutedly wound into a roll prior to proceeding to a converting operation) with a converting operation to emboss, print, deform, surface treat, or other post-forming operation known to those in the art. For purposes of the present invention, direct coupling means that the fibrous structure can proceed directly into a converting operation rather than, for example, being convolutedly wound into a roll and then unwound to proceed through a converting operation.

The process of the present invention may include preparing individual rolls of fibrous structure and/or sanitary tissue product comprising such fibrous structure(s) that are suitable for consumer use. The fibrous structure may be contacted by a bonding agent (such as an adhesive and/or dry strength agent), such that the ends of a roll of sanitary tissue product according to the present invention comprise such adhesive and/or dry strength agent.

The process may further comprise contacting an end edge of a roll of fibrous structure with a material that is chemically different from the filaments and fibers, to create bond regions that bond the fibers present at the end edge and reduce lint production during use. The material may be applied by any suitable process known in the art. Non-limiting examples of suitable processes for applying the material include non-contact applications, such as spraying, and contact applications, such as gravure roll printing, extruding, surface transferring. In addition, the application of the material may occur by transfer from contact of a log saw and/or perforating blade containing the material since, for example, the perforating operation, an edge of the fibrous structure that may produce lint upon dispensing a fibrous structure sheet from an adjacent fibrous structure sheet may be created.

### Non-Limiting Example of Fibrous Structure of the Present Invention

A 20%:27.5%47.5%:5% blend of Lyondell-Basell PH835 polypropylene:Lyondell-Basell Metocene MF650W polypropylene:Exxon-Mobil PP3546 polypropylene:Polyvel S-1416 wetting agent is dry blended, to form a melt blend. The melt blend is heated to 475° F. through a melt extruder. A 15.5 inch wide Biax 12 row spinnerette with 192 nozzles per cross-direction inch, commercially available from Biax Fiberfilm Corporation, is utilized. 40 nozzles per cross-direction inch of the 192 nozzles have a 0.018 inch inside diameter while the remaining nozzles are solid, i.e. there is no opening in the nozzle. Approximately 0.19 grams per hole per minute (ghm) of the melt blend is extruded from the open nozzles to form meltblown filaments from the melt blend. Approximately 375 SCFM of compressed air is heated such that the air exhibits a temperature of 395° F. at the spinnerette. Approximately 475 g/minute of Golden Isle (from Georgia Pacific) 4825 semi-treated SSK pulp is defibrillated through a hammermill to form SSK wood pulp fibers (solid additive). Air at 85-90° F. and 85% relative humidity (RH) is drawn into the hammermill. Approximately 1200 SCFM of air carries the pulp fibers to a solid additive spreader. The solid additive spreader turns the pulp fibers and distributes the pulp fibers in the cross-direction such that the pulp fibers are injected into the meltblown filaments in a perpendicular fashion through a 4 inch×15 inch cross-direction (CD) slot. A forming box surrounds the area where the meltblown filaments and pulp fibers are commingled. This forming box is designed to reduce the amount of air allowed to enter or escape from this commingling area; however, there is an additional 4 inch×15 inch spreader opposite the solid additive spreader designed to add cooling air. Approximately 1000 SCFM of air at approximately 80° F. is added through this additional spreader. A forming vacuum pulls air through a collection device, such as a patterned belt, thus collecting the commingled meltblown filaments and pulp fibers to form a fibrous structure comprising a pattern of non-random, repeating microregions. The fibrous structure formed by this process comprises about 75% by dry fibrous structure weight of pulp and about 25% by dry fibrous structure weight of meltblown filaments.

Optionally, a meltblown layer of the meltblown filaments can be added to one or both sides of the above formed fibrous structure. This addition of the meltblown layer can help reduce the lint created from the fibrous structure during use by consumers and is preferably performed prior to any thermal bonding operation of the fibrous structure. The meltblown filaments for the exterior layers can be the same or different than the meltblown filaments used on the opposite layer or in the center layer(s).

The fibrous structure may be convolutedly wound to form a roll of fibrous structure. The end edges of the roll of fibrous structure may be contacted with a material to create bond regions.

### Test Methods

Unless otherwise indicated, all tests described herein including those described under the Definitions section and the following test methods are conducted on samples that have been conditioned in a conditioned room at a temperature of 73° F.±4° F. (about 23° C.±2.2° C.) and a relative humidity of 50%±10% for 2 hours prior to the test. Samples conditioned as described herein are considered dry samples (such as “dry fibrous structures”) for purposes of this invention. Further, all tests are conducted in such conditioned room.

### Elongation, Tensile Strength, TEA And Modulus Test Methods

Cut at least eight 1 inch wide strips of the fibrous structure and/or sanitary tissue product to be tested in the machine direction. Cut at least eight 1 inch wide strips in the cross direction. If the machine direction and cross direction are not readily ascertainable, then the cross direction will be the strips that result in the lower peak load tensile. For the wet measurements, each sample is wetted by submerging the sample in a distilled water bath for 30 seconds. The wet property of the wet sample is measured within 30 seconds of removing the sample from the bath.

For the actual measurements of the properties, use a Thwing-Albert Intelect II Standard Tensile Tester (Thwing-Albert Instrument Co. of Philadelphia, Pa.). Insert the flat face clamps into the unit and calibrate the tester according to the instructions given in the operation manual of the Thwing-Albert Intelect II. Set the instrument crosshead speed to 4.00 in/min and the 1st and 2nd gauge lengths to 4.00 inches. The break sensitivity is set to 20.0 grams and the sample width is set to 1.00 inch. The energy units are set to TEA and the tangent modulus (Modulus) trap setting is set to 38.1 g.

After inserting the fibrous structure sample strip into the two clamps, the instrument tension can be monitored. If it shows a value of 5 grams or more, the fibrous structure sample strip is too taut. Conversely, if a period of 2-3 seconds passes after starting the test before any value is recorded, the fibrous structure sample strip is too slack.

Start the tensile tester as described in the tensile tester instrument manual. When the test is complete, read and record the following with units of measure:

Peak Load Tensile (Tensile Strength) (g/in)

Peak Elongation (Elongation) (%) (The average of MD Elongation and CD Elongation is reported as the Average Elongation)

Peak CD TEA (Wet CD TEA) (in-g/in²)

Tangent Modulus (Dry MD Modulus and Dry CD Modulus) (at 15 g/cm)

Test each of the samples in the same manner, recording the above measured values from each test. Average the values for each property obtained from the samples tested to obtain the reported value for that property.

### Basis Weight Test Method

Basis weight of a fibrous structure sample is measured by selecting twelve (12) individual fibrous structure samples and making two stacks of six individual samples each. If the individual samples are connected to one another vie perforation lines, the perforation lines must be aligned on the same side when stacking the individual samples. A precision cutter is used to cut each stack into exactly 3.5 in.×3.5 in. squares. The two stacks of cut squares are combined to make a basis weight pad of twelve squares thick. The basis weight pad is then weighed on a top loading balance with a minimum resolution of 0.01 g. The top loading balance must be protected from air drafts and other disturbances using a draft shield. Weights are recorded when the readings on the top loading balance become constant. The Basis Weight is calculated as follows:

$$Basis Weight ( lbs \text{/} 3000 {ft}^{2} ) = \frac{Weight of basis weight pad ( g ) \times 3000 {ft}^{2}}{\begin{matrix}453.6 g \text{/} lbs \times 12 samples \times \\ [ 12.25 {in}^{2} ( Area of basis weight pad ) / 144 {in}^{2} ]\end{matrix}}$$

$$Basis Weight ( g \text{/} {m}^{2} ) = \frac{Weight of basis weight pad ( g ) \times 10 , 000 {cm}^{2} \text{/} {m}^{2}}{79.0321 {cm}^{2} ( Area of basis weight pad ) \times 12 samples}$$

The filament basis weight of a fibrous structure is determined using the Basis Weight Test Method after separating all non-polypropylene materials from a fibrous structure (examples of methods for completing the separation are described below in the Weight Average Molecular Weight/Polydispersity Test Method).

### Weight Average Molecular Weight/Polydispersity Test Method

The weight average molecular weight of the polypropylene present in the polypropylene fibrous elements, such as polypropylene filaments, a fibrous structure is determined by high temperature gel permeation chromatography (GPC). Any non-propylene material present in the fibrous structure must be separated from the polypropylene filaments. Different approaches may be used to achieve this separation. For example, the polypropylene filaments may be first removed by physically pulling the polypropylene filaments from the fibrous structure. In another example, the polypropylene filaments may be separated from the non-polypropylene material by dissolving the non-polypropylene material in an appropriate dissolution agent, such as sulfuric acid or Cadoxen.

In yet another approach, the step of separating the polypropylene filaments from non-polypropylene material may be combined with the dissolution of the polypropylene such that a portion of the fibrous structure with about 30 mg of polypropylene is placed in about 10-15 ml of 1,2,4-tricholorbenzene (TCB). This is heated to about 150° C. for about 3 hours with gentle shaking during the last 20 minutes of heating. This process dissolves the polypropylene. The hot TCB solution/suspension is then filtered through a heated 2-10 μm stainless steel frit (filter) to remove the undissolved material (non-polypropylene material).

The weight average molecular weight distribution and polydispersity (Mw and PD (PD=Mw/Mn)) are measured using GPC with refractive index (RI) detection based on polystyrene (PS) narrow standard retention times with k and a correction values applied (PS narrow standards: k=4.14, α=0.61; Polypropylene: k=1.56, α=0.76). The GPC uses 10 mm Mixed B (3) columns with TCB containing 0.5% BHT as mobile phase at 150° C. with a 1 ml/minute flow rate. Sample injection volume is 200 μl.

### Diameter Test Method

The diameter of a polypropylene fibrous element, especially a polypropylene microfiber fibrous element, in a fibrous structure is determined by taking scanning electromicrographs of the fibrous structure and determining the diameter of the polypropylene fibrous element from its image.

Alternatively, the diameter of a polypropylene fibrous element, especially a polypropylene microfiber fibrous element, is determined by removing, if necessary, the polypropylene fibrous element to be tested from a fibrous structure containing such polypropylene fibrous element. The polypropylene fibrous element is placed under an optical microscope. The diameter of the polypropylene fibrous element is measured using a calibrated reticle and an objective of 100 power. Read the diameter of the polypropylene fibrous element in at least 3 positions (in the center of the visible polypropylene fibrous element and at 2 or more positions along the length of the polypropylene fibrous element near opposite boundaries of the viewing area). The average of the diameter measurements at the 3 or more positions is averaged and reported as the diameter of the polypropylene fibrous element.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and

[symbol]

What is claimed is:

1. A polypropylene microfiber fibrous element, the polypropylene microfiber fibrous element comprising a polypropylene composition comprising:
a. a first polypropylene polymer that exhibits a melt flow rate of less than 50 g/10min;
b. a second polypropylene polymer that exhibits a melt flow rate of from about 200 to about 700 g/10 min; and
c. a third polypropylene polymer that exhibits a melt flow rate of greater than 1000 g/10 min.

2. The polypropylene microfiber fibrous element according to claim 1 wherein the polypropylene microfiber fibrous element exhibits a diameter of less than 5 μm.

3. The polypropylene microfiber fibrous element according to claim 2 wherein the polypropylene microfiber fibrous element exhibits a diameter of less than 2 μm.

4. The polypropylene microfiber fibrous element according to claim 1 wherein the first polypropylene polymer exhibits a melt flow rate of from about 15 to less than 50 g/10 min.

5. The polypropylene microfiber fibrous element according to claim 1 wherein the second polypropylene polymer exhibits a melt flow rate of from about 300 to about 600 g/10 min.

6. The polypropylene microfiber fibrous element according to claim 1 wherein the third polypropylene polymer exhibits a melt flow rate of from about 1,000 to about 2,000 g/10 min.

7. The polypropylene microfiber fibrous element according to claim 1 wherein the first polypropylene polymer is present in the polypropylene composition at a level of from about 5 to about 30% by weight of the polypropylene composition.

8. The polypropylene microfiber fibrous element according to claim 1 wherein the second polypropylene polymer is present in the polypropylene composition at a level of from about 20 to about 60% by weight of the polypropylene composition.

9. The polypropylene fibrous element according to claim 1 wherein the third polypropylene polymer is present in the polypropylene composition at a level of from about 10 to about 60% by weight of the polypropylene composition.

10. The polypropylene microfiber fibrous element according to claim 1 wherein the first polypropylene polymer and second polypropylene polymer are present in the polypropylene composition at a weight ratio of first propylene polymer to second polypropylene polymer of from about 1.5:1 to about 1:12.

11. The polypropylene microfiber fibrous element according to claim 1 wherein the first polypropylene polymer and third polypropylene polymer are present in the polypropylene composition at a weight ratio of first propylene polymer to third polypropylene polymer of from about 3:1 to about 1:12.

12. The polypropylene microfiber fibrous element according to claim 1 wherein the second polypropylene polymer and third polypropylene polymer are present in the polypropylene composition at a weight ratio of second propylene polymer to third polypropylene polymer of from about 6:1 to about 1:3.

13. The polypropylene microfiber fibrous element according to claim 1 wherein at least one of the first, second, and third polypropylene polymers is a polypropylene copolymer.

14. The polypropylene fibrous element according to claim 1 wherein at least one of the first, second, and third polypropylene polymers is a polypropylene homopolymer.

15. The polypropylene microfiber fibrous element according to claim 1 wherein the polypropylene microfiber fibrous element further comprises a wetting agent.

16. The polypropylene microfiber fibrous element according to claim 15 wherein the wetting agent is a melt additive wetting agent present in the polypropylene composition.

17. The polypropylene microfiber fibrous element according to claim 1 wherein at least one of the first, second and third polypropylene polymers is an elastomeric polypropylene polymer.

18. The polypropylene microfiber fibrous element according to claim 17 wherein the elastomeric polypropylene polymer comprising a polypropylene copolymer.

19. The polypropylene microfiber fibrous element according to claim 18 wherein the polypropylene copolymer is a polyethylene/polypropylene block copolymer.

20. A fibrous structure comprising one or more polypropylene microfiber fibrous elements according to claim 1.

21. The fibrous structure according to claim 20 wherein the fibrous structure further comprises a plurality of solid additives.

22. The fibrous structure according to claim 20 wherein the fibrous structure exhibits an average elongation of greater than 50% as measured according to the Elongation Test Method described herein.

23. The fibrous structure according to claim 20 wherein the fibrous structure exhibits a total dry tensile/filament basis weight value of greater than 20 g/in/g/m².

24. A process for making a polypropylene microfiber fibrous element, the process comprising the step of spinning a polypropylene microfiber fibrous element from a polypropylene composition comprising:
a. a first polypropylene polymer that exhibits a melt flow rate of less than 50 g/10 min;
b. a second polypropylene polymer that exhibits a melt flow rate of from about 200 to about 700 g/10 min; and
c. a third polypropylene polymer that exhibits a melt flow rate of greater than 1000 g/10 min.

25. The process according to claim 24 wherein the polypropylene composition further comprises a melt additive wetting agent.

26. The process according to claim 24 wherein the process further comprises applying a surface wetting agent to the polypropylene microfiber fibrous element.

27. A fibrous structure comprising a plurality of polypropylene filaments and a plurality of solid additives, wherein the polypropylene present in the polypropylene filaments exhibits a weight average molecular weight of at least 78,000 and a polydispersity of less than 3.2.

28. The fibrous structure according to claim 27 wherein the polypropylene filaments comprise polypropylene microfiber filaments.

29. The fibrous structure according to claim 27 wherein the solid additives comprise wood pulp fibers.

30. The fibrous structure according to claim 27 wherein the polypropylene comprises two or more polypropylenes that exhibit different MFRs.

31. The fibrous structure according to claim 30 wherein the polypropylene comprises:
a. a first polypropylene polymer that exhibits a melt flow rate of less than 50 g/10 min;
b. a second polypropylene polymer that exhibits a melt flow rate of from about 200 to about 700 g/10 min; and
c. a third polypropylene polymer that exhibits a melt flow rate of greater than 1000 g/10 min.

32. A polypropylene microfiber fibrous element made from a polypropylene composition comprising:
a. a first polypropylene polymer that exhibits a melt flow rate of less than 50 g/10 min;
b. a second polypropylene polymer that exhibits a melt flow rate of from about 200 to about 700 g/10 min; and
c. a third polypropylene polymer that exhibits a melt flow rate of greater than 1000 g/10 min.
